(19) United States
(12) Patent Application Publication
(10) Pub. No.: US 2018/0008848 A1
(43) Pub. Date: Jan. 11, 2018

(54) FACE MASK WITH REMOVABLE/REPLACEABLE FILTER ELEMENT

(71) Applicant: Sleepnet Corporation, Hampton, NH (US)

(72) Inventors: Thomas M. Moulton, Rye, NH (US); Jerry J. Gong, Andover, MA (US)

(73) Assignee: Sleepnet Corporation, Hampton, NH (US)

(21) Appl. No.: 15/631,090

(22) Filed: Jun. 23, 2017

Related U.S. Application Data
(60) Provisional application No. 62/358,711, filed on Jul. 6, 2016.

(51) Int. Cl. A62B 23/02; A62B 18/08; A62B 18/02; A62B 23/00; A41D 13/11

(52) U.S. Cl. CPC A62B 23/025; A62B 23/00; A41D 13/11; A62B 18/02; A62B 18/08

(57) ABSTRACT

The present invention is a particulate filter face mask with replaceable filter element, the filter element being inexpensive, easily replaceable and securely held within the mask when installed.

### BACKGROUND

Face masks are worn to filter out particles and unwanted gases from air, making air breathable for the wearer. With regard to particle filtration, prior art masks are often ineffective and/or uncomfortable for the wearer. Ineffective prior art masks frequently do not seal well and allow air to bypass the filter by, for example, passing between the mask edge and wearer's face or around the filter element, thus exposing the wearer to contaminants. Ineffective masks offer limited wearer protection and increase negative health consequences.

Uncomfortable masks result in lower user compliance and also cause increased health consequences. Uncomfortable masks may press into the wearer's face in one or more areas, be too heavy for long term wearing or result in condensation buildup under the mask, causing the wearer to shift the mask in an effort to permit the condensation to evaporate by to allowing unfiltered air in under the mask edge.

Some particulate filtering masks are single use masks. Single use masks tend to be poor fitting. Single use masks also require frequent replacement, which can be expensive over time.

Some styles of masks have replaceable filter elements but the filter elements tend to be either cumbersome to wear or exchange, such as cartridges or canisters, or the filters do not seal well, adding another entry point for contaminants. Other filter masks have replaceable filter elements without the supportive features of a canister but do not provide adequate support or retention of the filter element to prevent the filter element from shifting and leaking, thereby creating a hazard for users.

For example, U.S. Pat. No. 2,578,007 is directed towards a mask with a replaceable filter element. However, the only support provided for the filter element is at the edge of the filter element and, therefore, the filter may move or shift and leak when used, or cave in, causing user discomfort or requiring frequent filter changes.

U.S. Pat. No. 2,845,927 is directed towards a face mask with a removable filter element. However, like the mask described above, it is only clamped around the edges providing inadequate support to prevent moving and shifting.

U.S. Pat. No. 6,817,362 is directed towards a face mask with a non-flexible, formed, cup-shaped filter element. While the filter element may be less likely to move or shift like those described above, the use of a formed filter element adds extra expense to the manufacture and shipping of the filter elements.

WO 2015/006679 is directed towards a filter mask with replaceable filter elements. However, the filter element must be secured by being pressed onto ribbed studs. This has two disadvantages. First, the process is relatively time consuming and, second, the studs may cause areas in which leaks may occur allowing particulates entry to the mask.

WO 2015/168077 is directed towards a filter mask with a replaceable filter. The mask is designed to provide an optimized angle for the filter in relation to the user's mouth and nose. However, the mask does not seem to provide the filter support for the replaceable filter element or requires a rigid filter element.

WO 2010/064862 is a Korean language publication directed towards a face mask with a replaceable filter element. The filter element is housed in a frame. This design is costly compared to designs without an integral frame.

What is needed in the art is a comfortable face mask that is effective in filtration, inexpensive to use, especially with regard to the disposable filter element, and comfortable to wear ensuring user compliance.

### SUMMARY OF THE INVENTION

The present invention solves several of the problems associated with prior art particle filter face masks. The face mask of the present invention permits a large volume of air flow to the wearer while being lightweight, sealing well, being comfortable to wear and essentially eliminating condensation build up under the mask. It is also cost effective to use having inexpensive, replaceable filter elements. The face mask of the present invention has, among other attributes, a unique design that permits the rapid exchange of the inexpensive filter elements; a design that also holds the filter elements securely in the mask without leakage of air around the filter either during inhaling or exhaling by the user. Further, the design of the mask eliminates or substantially eliminates condensation in the mask and air leakage around the mask periphery.

The present invention is also directed towards a method of providing filtered, particulate free air to a user by donning of the face mask of the present invention consistent with instructions for its use. Instructions may be provided with the mask that includes direction with regard to use of the mask and replacement of the filter element. In this regard, the front grill element of the mask is removable for filter element replacement. In one embodiment, replacement of the filter element comprises insertion of the tab into the tab recess on the front grill element and placement of the filter element on the front grill element over the support elements of the front grill element. In another embodiment, the filter does not have a tab and the mask does not have a tab recess. The filter is positioned in the front grill element over the support elements. In another embodiment, it is contemplated that the filter is placed on the mask body and the filter is sandwiched between the front grill and mask body when the front grill is attached to the mask body. The front grill element can then be placed into position over the mask body and secured. The front grill may be hinged or tethered to the mask body.

One of the problems in the prior art with regard to the use of flexible, replacement filter elements in a face mask is that the filter element can move or shift in the mask, causing leaks. This has required the prior art development and use of filter elements that are fitted to a frame or other support, the entire unit of filter and support being replaced. This, or course, makes the filter element expensive to replace. The present invention solves this problem by incorporating filter support elements into the mask body and the front grill element. The support elements of the mask body align with the support elements of the removable front grill element and are of equivalent width and length as the support elements of those on the removable front grill element.

Further, the support elements of the mask body and/or front grill element may further comprise raised elements to securely hold the filter element in place. The support elements and/or raised elements may also further comprise “fine grip elements” to provide highly localized contact on the filter element. The fine grip elements may resemble pins, bumps, posts and the like. A support element of the mask body and/or front grill element may comprise a single raised element that extends up to the length of the support element. It is also contemplated that the raised element may be shorter than the support element. The design of this mask, with support elements and/or raised elements and/or fine grip elements provide for the required support of the filter element, maintain the position of the filter element while also providing for minimum interference with air flow. Thus, the mask of the present invention is comfortable, has easily replaceable inexpensive filter elements and provides adequate air flow while not being too large or cumbersome for ease of use.

A flexible filter element is sandwiched between the front grill element and the mask body when the front grill element is attached to the mask body. The present invention also contemplates that the flexible filter element is comprised substantially of one material. The flexible filter element may also comprise a stiffener to, for example, help in positioning of the filter element and to provide rigidity. The stiffener may be an after manufacture additive such as a coating or substance impregnated into the filter element, or it may be a substance more rigid that the filter element material located on the surface of the filter element or sandwiched between layers of filter element material.

Further, the face mask of the present invention has a face seal with an unconventional shape that provides a comfortable seal with the user's face and is effective in preventing most if not all air leaks at the mask-face interface. The seal is made of soft, pliable material and is shaped for user comfort, as described below. The present invention also contemplates that the flexible seal positioned on the mask body so as to make a seal between the mask and a user's face when the mask is worn is substantially V-shaped. The present invention also contemplates that the flexible seal has extensions at the position of the mask body that is positioned adjacent to the user's nose when being worn.

The present invention also contemplates that the mask body further comprises a one-way valve to allow release of exhaled air and that the one-way valve is positioned in front of the user's mouth when the mask is worn.

The present invention also contemplates that the face mask additionally comprises a means for securing the mask to the user's head and that, optionally; the means for securing the mask to the user's head is attached to the front grill element or mask body of the face mask of the present invention.

The means for securing the mask to the users head is referred to as “head gear” in this specification. In this regard, the head gear of the face mask of the present invention can be any head gear known to one of ordinary skill in the art. In this regard, it is contemplated that the face mask of the present invention comprises a means for securing the mask to the user's head that comprises a first and a second ear hook, a first strap element attached to the first ear hook and a second strap element attached to the second ear hook, said strap elements attached to the forward portion of the ear hook and positioned at about midway from the top to the bottom of the ear, said first strap element extending through a first head gear connector on the face mask and said second strap element extending though a second head gear connector on the face mask and said first and second straps joining with an attachment means such as a slide mechanism. When worn, the positioning of the head gear, the positioning of the strap attachment point and the adjustable nature of the pressure generated by the strap elements keep the mask seal in contact with the user's face. The first strap element and second strap element can be separate straps or portions of one strap.

The present invention also contemplates that the face mask body and the front grill element being fabricated from a moldable polymer.

The present invention also contemplates that the flexible filter element is made from a non-woven fiber material and that the non-woven fiber material may be selected from the group consisting of polypropylene (PP), rayon and polyethylene terephthalate (PET). The present invention further contemplates that the flexible filter element is a particulate filter and is electrostatically charged and, optionally, may comprise activated charcoal. Further, as discussed above, a stiffener can be used with the filter element to aid in positioning of the filter element and to aid in preventing the filter from moving during use, if this feature is deemed preferred or necessary.

The present invention contemplates a kit having a face mask for holding a removable flexible filter element, the kit comprises a face mask for holding a removable flexible filter element and instructions for use. The face mask comprises a mask body contoured to a user's face with the mask body having an opening located in front of (substantially forward) of the user's mouth and nose. The opening has multiple support elements for providing support to a flexible filter element, and a flexible seal positioned on the mask body so as to make a seal between the mask and a user's face when the mask is worn. The front grill element is removable and reattachable and comprises support elements. The support elements are substantially in alignment with the support elements of the mask body when the front grill element is attached to the mask body. The support elements of the mask body and/or front grill element have one or more raised elements (with or without fine grip elements to aid in positioning and securing the filter element). The raised elements and/or fine grip elements on the support elements of the mask body (substantially) face the raise elements and/or fine grip elements, if present, on support elements of the front grill element when the front grill element is attached to the mask body. A flexible filter element is sandwiched between the front grill element and the mask body when the front grill element is attached to the mask body and the raised elements on the support elements of the mask body and the support elements of the front grill element exert pressure on the flexible filter element to keep the flexible filter element from moving parallel to the plain of the flexible filter element.

### DESCRIPTION OF THE FIGURES

FIG. 1A shows an embodiment of the face mask of the present invention.

FIG. 1B shows another embodiment of the face mask of the present invention.

FIG. 2A-C shows the mask body of FIG. 1A from the front (A) and side (B) as well as a as a cross section of a support element with raised element (C).

FIG. 2D-F shows the mask body of FIG. 1B from the front (D) and side (E) as well as a cross section of a support element with raised element and pin (F)

FIG. 3A shows the face mask of FIG. 1A disassembled.

FIG. 3B shows the face mask of FIG. 1B disassembled.

FIGS. 4A & B shows the face seal of the face mask of the present invention. (A) shows the seal and (B) shows a cross section of the seal.

FIG. 5A shows the face mask of FIG. 1A with head gear.

FIG. 5B shows the face mask of FIG. 1B with head gear.

### DETAILED DESCRIPTION OF THE INVENTION

The present invention will now be described in view of the figures. The numbering of parts in the figures is not repeated for the same part in subsequent figures for clarity but should be evident from the figures.

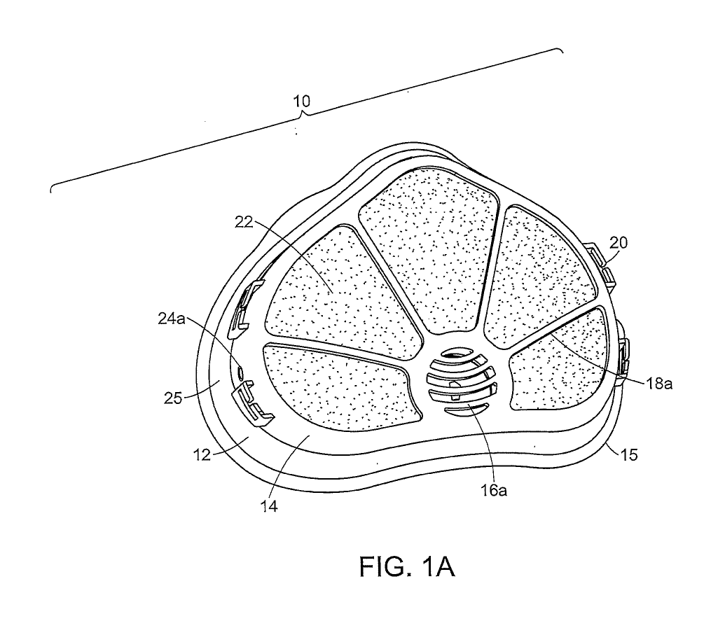

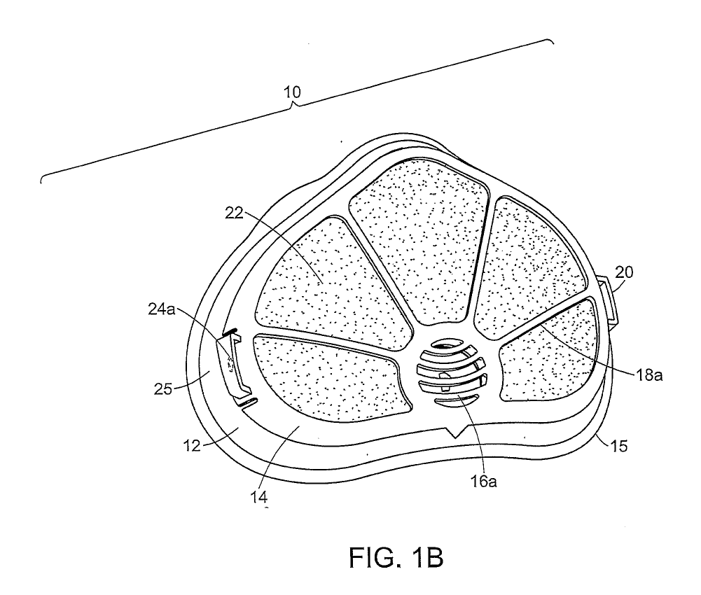

Looking at FIGS. 1A and 1B, embodiments of the face mask of the present invention are shown. The face mask 10 has a mask body 12 and a front grill element 14. The mask body has a soft, flexible face seal 15. The front grill element has support elements 18a, connectors 20 for head gear (i.e., straps or similar) and at least one exhaust port grill 16a. The replaceable filter element 22 is positioned (i.e., sandwiched) between the mask body and front grill element. Holes or indentations 24a are present in the front grill element for receiving the nubs on the mask body when the mask is assembled.

As can be seen from the figures, the mask body of the face masks of the present invention is contoured to a user's face and have an opening located in front of the user's face (i.e., in front of the user's mouth and nose) when worn by the user. The opening, shared by the front grill element, houses the filter element 22 and at least one exhaust port 16a.

The face mask body and front grill element of the present invention may be made from one of more moldable polymers. Any suitable polymer may be used. Exemplary polymers known in the art include, but are not limited to, polyester, polyethylene terephthalate (PET), high-density polyethylene (HDPE), polyvinylidene cholate (PVDC), polyvinyl chloride (PVC), low density polyethylene (LDPE), polypropylene (PP), polystyrene (PS), high impact polystyrene (HIPS), polyamides (PA), polycarbonate (PC), acrylonitrile butadiene styrene (ABS), polycarbonate/acrylonitrile butadiene styrene (PC/ABS) and polyurethanes (PU).

The front grill element and associated filter element are designed to allow for a flow of air necessary for the user to breath comfortably. The filter area of the mask is dependent upon the nature of the filter material used but should have a surface area of about 6 square inches to about 15 square inches; about 7 square inches to about 12 square inches; or, about 8 square inches to about 10 square inches. The filter material should allow of a flow of about 0.5 to about 0.6 liters (L) of air with each breath or about 0.3 L to about 1.2 L; about 0.4 L to about 1.0 L or about 0.5 L to about 0.8 L with each breath. During moderate exertion such as during work the volume of air inhaled and exhaled may increase and/or the rate of breathing may increase.

The filter element of the present invention is, in a preferred embodiment, flexible and thin (i.e., a flexible filter element). The filter element is designed to filter out particulates and, in some instances, odors, making inhaled air safer for the user. Filter elements of the present invention may comprise, consist essentially of or consist of one material. Filter elements of the present invention may also be composed of more than one material. Multiple materials may be interwoven, for example, to give the appearance of one material. In this regard, each material may provide certain benefits to the filter. For example, one material may provide filtering capability while another material may provide a degree of rigidity while still permitting flexibility of the filter element. It is also contemplated that the filter element may be composed of more than one material and the materials are distinguishable from one another. For example, a filter element of the present invention may be composed of fibers to provide filter capability and activated charcoal to provide odor removal.

Suitable materials for the filter element of the present invention include, but are not limited to, polypropylene (PP), rayon and polyethylene terephthalate (PET), and others as are known to one of skill in the art. The filter element material may be, for example, melt blown or spun bond to provide fibers of a suitable diameter and density. The fibers may be formed into a nonwoven material of the required thickness and die cut to shape. Die cutting may include heat sealing of the edge of the filter element to keep the fibers from fraying or otherwise coming apart. Filter materials are preferably electrostatically charged to help capture particulates. The product TECHNOSTAT®, from Superior Felt & Filtration (McHenry, II), or equivalent, may be used to provide electrostatic properties for the filter material. TECHNOSTAT® is a surface charged tribo-electret needle-punched felt that filters out particles as small as 1 micron in in size, as small as 0.5 micron in size or as small as 0.3 micron in size.

In one embodiment, it is contemplated that the initial resistance of the filter shall be less that about or equal to 16.0 mm H₂O at 32 LPM (100 cm² sample). NaCl penetration is not to exceed about 1.5% at 32 LPM (100 cm² sample). NaCl aerosol penetration is a measure of the electrostatic capacity of the material to bind and hold particulates, as is known to one of ordinary skill in the art. The thickness of the filter element of the present invention is approximately 1.0 mm to 3.0 mm or 1.5 mm to 2.5 mm. The filters of the present invention may be, for example, die or laser cut from a sheet roll of suitable material. It is further contemplated that the filter material of the filter element of the present invention filter captures at least 80%, at least 85% at least 90% at least 95% at least 98% or at least 99% of air borne particles. The density of the filter material of the present invention can range for 50-1000 g/M², 100-500 g/M², 150-400 g/M² or 200-300 g/M². One supplier of suitable filter materials for the present invention is Superior Felt & Filtration (McHenry, II).

The filter element is preferred to be a flexible element made of non-woven fibers. However, it is contemplated that the filter element may also be made of other materials such as woven fibers or foam (e.g., open cell foam of the correct porosity to provide adequate particulate filtering). Further, the filter element may be comprised of one or more materials. A filter element is composed of substantially one material means that the filter element is composed of at least 75%, at least 85%, at least 95% of one material. The materials may be suitable for particulate filtering or may provide other benefits such as absorption of odor or provide strength or a degree of rigidity to the filter element. In this regard, the filter element may have a degree of rigidity such that the filter element has the same general shape and contours of the position it occupies between the mask body and the front grill element, while still having a degree of flexibility.

In this regard, in another embodiment, it is contemplated that the filter element is rigid or semi-rigid. Semi-rigid is defined herein as meaning “stiff and solid to the point of being able to hold a shape but not inflexible.” A rigid or semi-rigid filter element would have the general shape of the area between the front grill element and mask body when the front grill element and mask body are joined. Although more costly to make, in some situations a rigid or semi-rigid filter element may protect the user from larger particulates that may puncture a flexible filter element. In another embodiment, it is contemplated that the filter element (flexible, rigid or semi-rigid) comprises reinforcement fibers. Reinforcement fibers, if used, may be composed of nylon, for example, or other material of high tensile strength. In other words, optionally, a stiffener may be used to help stiffen the filter element while still allowing some flexibility.

The flexible seal of the face mask is composed of a soft, flexible material. The soft flexible material described in U.S. Pat. No. 7,219,669 to Lovell, et al. (which is incorporated herein by reference in its entirety) is suitable for the flexible seal of the present invention. Briefly, the material described in the '669 patent is a bladder filled with a molded material in a predetermined configuration. The material has a durometer value less than about ten on a Shore 000 scale. The seal is configured typically with a slight crown to seal against external skin proximate at least one naris at a base of a nose of a user. The material can be silicone. Other materials may be used including foam, rubber and suitable flexible plastics, as are known in to one of ordinary skill in the art.

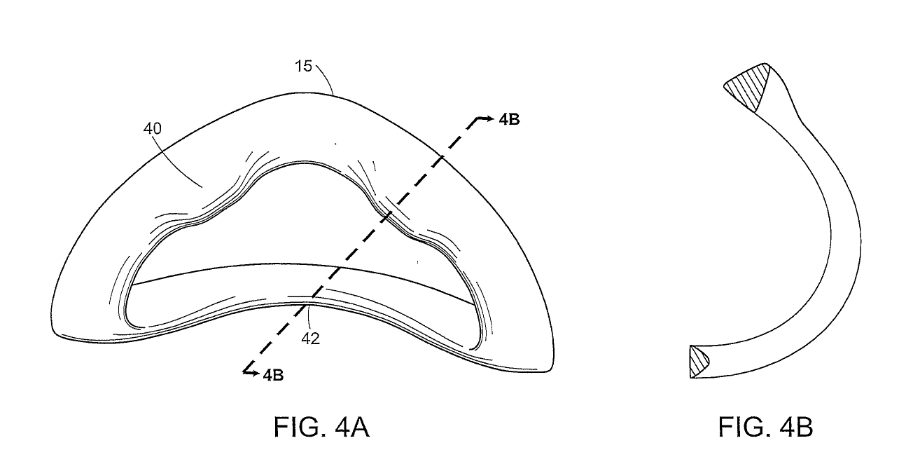

The seal of the face mask of the present invention may have a unique shape and geometry (see, FIGS. 4A and B, 15). For example, in cross section the seal is approximately or essentially “V” shaped or has a rounded “V” shape 42. In other words, instead of the seal having the ubiquitous prior art rounded shape or rounded crown; the seal of the present invention has a sharper, sharp or pointed crown. To put it another way, the seal of the present invention does not have an equal or essentially equal diameter in cross section. The present inventors have found that the shape of the seal of the present invention provides a better seal to the user's face than the round seals of the prior art. With regard to the seal of the present invention, the relatively acute angle of the “V” (i.e., the point of the “V”) is positioned against the user's face when the mask is worn. To describe the shape of the seal in another way, the seal has a parabolic shape that is more or less “V” shaped and not semicircle shaped. It has been found by the present inventors that the shape of the seal of the present invention allows for movement of movement of the mask on the user's face, for example, while breathing, talking or other motion, without breaking the seal with the user's face. In other words, the mask body may move relative to the user's face due to user facial movement, but the seal will remain in position on the user's face. This is important because every time a face mask breaks seal, particulates can enter through the break and contaminate the air in the area contained under the mask.

The seal of the mask of the present invention also has additional features to aid in the sealing of the mask to the user's face. As can be seen in FIG. 4A, the seal has two projections or tabs 40, positioned such that when the mask is worn one projection is positioned on either side of the bridge on the user's nose. These tabs or extensions are effective in sealing this area, an area that is typically prone to leakage due to incomplete or poor sealing by seals that are the same shape along the entire length. Although not limited by size, the tabs are typically from about ¾″ to about 1¼″ long and project approximately ⅛″ to approximately ¼″ from the crown of the remainder of the seal. In other words, in the area of the seals, the “V” shape or crown extends about ⅛″ to about ¼″ further from the mask edge than the remainder of the seal.

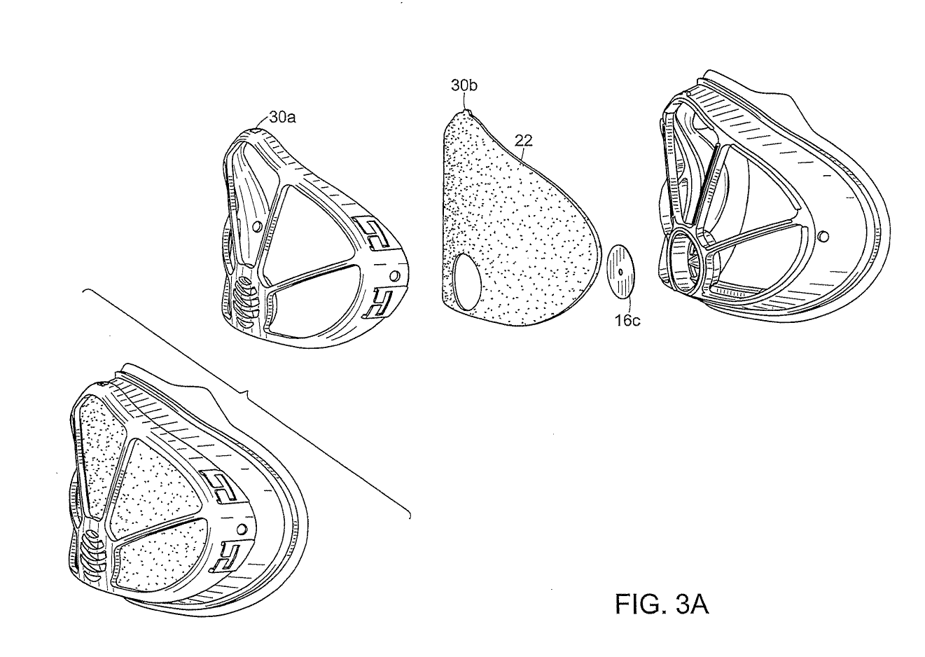

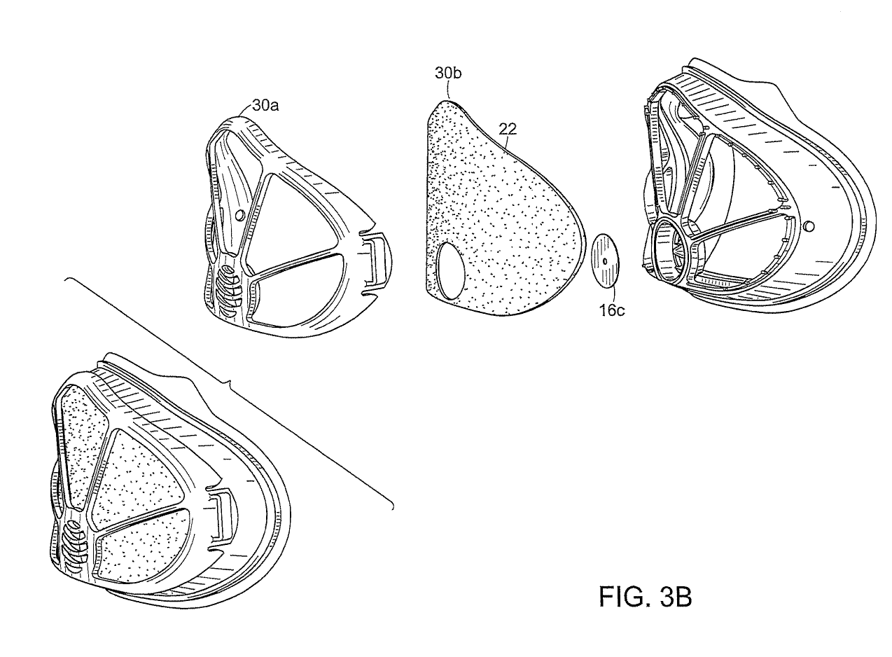

The face masks of the present invention also have at least one exhaust port. The at least one exhaust port is preferably located in the lower center of the mask to be positioned in front of the user's mouth and nasal passages when the mask is worn. This positioning is important with regard to user's comfort and user compliance. This positioning of the exhaust valve allows for the expelling of used air directly from the user's mouth and nasal passages out of the mask and into the environment. Prior art masks typically have exhaust ports located at the side of the mask or expect the filter material to double as the exhaust medium (for example, paper throwaway masks function this way). These prior art designs cause moisture from the user's exhaled breath to condense inside the mask. This makes the mask uncomfortable to wear for anything but a short period of time and often leads to user's “repositioning” the mask to allow unfiltered air into the mask for cooling and evaporation of condensation. In contrast, the design of the present invention allows for significantly decreased condensation or eliminates condensation from forming inside of the mask when worn thereby achieving higher user compliance rates than with the prior art designs. The exhaust port valve in the mask of the present invention may be replaceable (see, number 16c in FIGS. 3A & B).

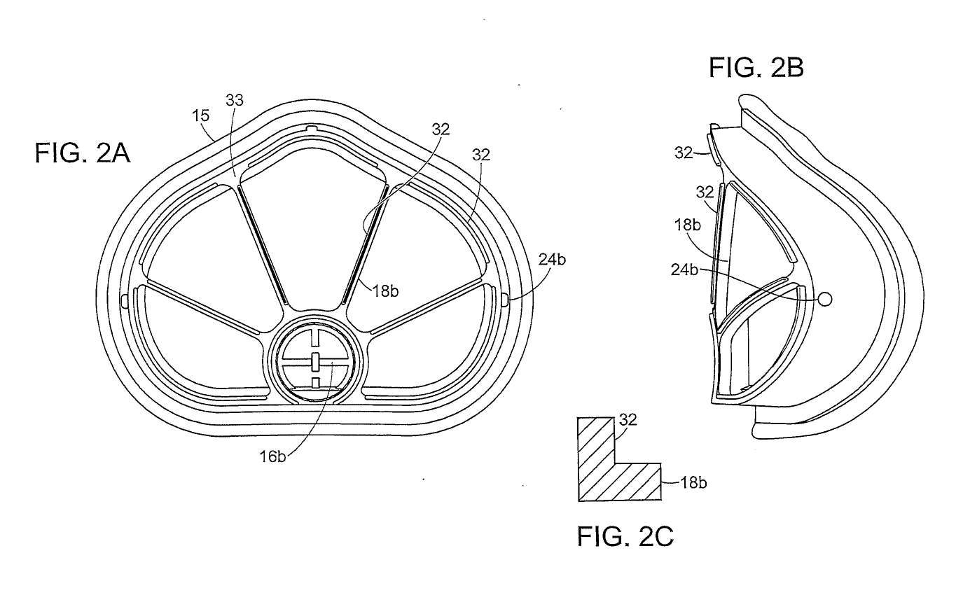

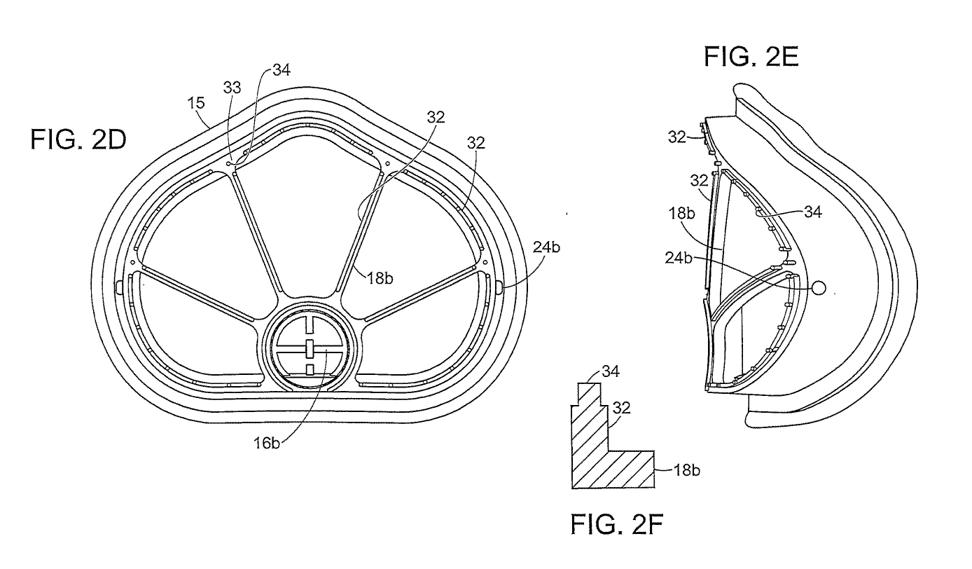

Shown in FIGS. 2A, 2B, 2D and 2E is the mask body with the front grill element removed. The exhaust port 16b can be seen with the exhaust valve removed. On either side of the mask body nubs 24b are present over which the holes on the front grill element are secured.

The front grill element of the mask is held on the mask body by two or more attachment points. Although the present invention is not limited to a particular means for attaching the front grill element to the mask body of the present invention, the attachment points may be, for example, raised nubs or bumps on mask body that fit into holes or indentations on the front grill element of the mask, as discussed above. Other methods of attachment are known to one of ordinary skill in the art, such as hooks, snaps, latch and hook material, friction or pressure fit, etc., and may be incorporated in the present invention. Further, the front grill element may be held on to the mask body with clips on the front grill element that clip onto the edge of the opening in the mask body (or clips on the mask body that clip onto the front grill element). Further still, there may be one or more “nub and hole (or recess)” attachment points at the top, bottom or other position on the front grill element and mask body. If the front grill element is held on by “nubs 24b and holes 24a” then the front grill element is snapped onto the mask body securing (sandwiching) the filter element between the front grill element and mask body. Other attachment means work similarly in that the filter element is secured between the front grill element and the mask body.

The mask body and front grill element have multiple support elements for providing support to a flexible filter element. The support elements of the mask body can be in alignment or substantially in alignment with the support elements of the front grill element when the mask is assembled by installing the front grill element on the mask body. Further, the support elements of the mask body are contemplated to be the same dimensions or substantially the same dimensions and the support elements of the front grill element.

The support elements of the mask body and/or front grill element may optionally have one or more raised elements. The raised elements provided on the support elements of the mask body or front grill element (substantially) face the support elements and/or raised elements of the opposing front grill element or mask body, respectively, when the front grill element is attached to the mask body. A raised element may extend the length of a support element or be shorter than a support element. If shorter, more than one raised element may be located on a support element. It is further contemplated that the raised elements may extend completely (be continuous) over the support elements. It is also further contemplated that the raised elements may be, or not be, on the mask body and/or front grill element around the periphery or surround of the filter area (see, for example, 33 on FIG. 2A). The raised elements may be the same width, wider or narrower as the support elements. The raised elements may be located on the face mask body support elements, on the front grill element support elements or both. If the raised elements are located on both the face mask body support elements and the front grill element support elements, the raised elements on the mask body may be may be aligned with and positioned opposite to the raised elements on the front grill element. It is also contemplated that the raised elements may be positioned such that when the front grill element is attached to the mask body the raised elements on respective, aligned support elements are positioned beside each other.

The edges of the raised elements may be squared on one or both edges or may be rounded on one or both edges. In any event, the raised elements of the support elements of the face mask of the present invention exert a pressure on the filter element at the support elements by sandwiching (i.e., pinching) the filter element between the support elements of the mask body and the support elements of the front grill element. The pressure exerted by this design is effective in keeping the filter element from slipping or moving from its position in a plane parallel with the filter to any appreciable extent. FIG. 2C shows a cross section of a support element with raised element.

Raised elements (exemplified in FIG. 2A at 32) are visible on the support elements 18b of the mask body. In FIG. 2B, the support elements and raised elements are seen from another angle. In FIG. 2C a cross section of one of the face mask body support elements 18b is shown with an embodiment of the raised elements 32 clearly visible.

Raised elements and/or support elements may further comprise a plurality of, for example, molded and/or attached protrusions. The protrusions may resemble, for example, bumps, posts, pins, and the like. The protrusions are referred to herein as “fine grip elements” (see, for example, 34 of FIGS. 2D and 2E). Fine grip elements, as the name implies, are points of highly localized contact of the mask body and/or front grill element with the filter element. If fine grip elements are on both the mask body and the front grill element, the fine grip elements of the mask body may align with the fine grip elements of the front grill element or may be staggered (not align) with the fine grip elements of the front grill element. In FIG. 2F a cross section of one of the face mask body support elements 18b is shown with an embodiment of the raised elements 32 and fine grip element 34 clearly visible.

In some instances, it is contemplated that the length of the raised elements may be very short with a plurality of raised elements located on a support element. In this embodiment, the raised elements function as fine grip elements.

The filter element of the face mask of the present invention is sandwiched between the mask body and the front grill element of the mask. The support elements apply pressure to the filter element and keep the filter element in position in the mask and from moving in a direction essentially perpendicular to or diagonal with the plane of the filter element. The raised elements and or fine grip elements, if present, further aid in keeping the filter element in position.

It is contemplated that the support elements of the mask body and front grill element cover or sandwich no more than about 50%, 40%, 30%, 20%, 15%, 10%, 5% or 2% of the surface area of the filter element. While not limited to any particular size, it is contemplated that the support elements of the mask body and front grill element are no wider that about 3/16 inch, ⅛ inch, 3/32 inch or 1/16 inch. The width is defined as being the side of the support element(s) visible when the face mask is viewed from the front, i.e., facing the user when the mask is worn. While not being limited to any particular size, it is contemplated that the support elements of the mask body are about ⅛ to ¼ inch deep or about 3/16 of an inch deep and that the support elements of the front grill element are about 3/32 to a 5/32 of an inch deep or about ⅛ inch deep.

The at least one exhaust port (16b) is composed of a cross member and circumferential support that keeps the exhaust valve from folding back into the mask. In one embodiment, in the center of the cross member is a post for securing the exhaust valve, the post may have a projection or projections, such a one or more barbs or “T” shaped projection to hold the value in place. The exhaust port may also have two projections that are perpendicular to the cross member and maybe positioned at the same plane as the cross member, or above the plane of the exhaust valve to hold the valve in position during exhaling. The exhaust valve is composed of a soft, flexible, thin rubber or rubber-like material (many examples which are known to those of ordinary skill in the art). The exhaust valve may have a center hole for fitting onto the post, if present. The exhaust valve in some embodiments is replaceable (see, FIGS. 3A & B, 16c). For example, after removal of the front grill element from the mask body, the exhaust valve can be pulled off of the post and a new exhaust valve can be fit over the post, by stretching if necessary, and placed into position.

The front grill element of the mask and mask body may be reversibly attached to each other by any suitable method known in the art. A preferred method is by snapping the front grill element onto the mask body by engaging snapping elements together. In one embodiment the snapping elements are nubs or bumps 24a located on the mask body and receiving holes 24b located on the front grill element. The nubs and holes are located, in one embodiment of the present invention, at the sides of the respective mask parts. One nub in conjunction with one hole comprise an attachment point. A user would remove the front grill element from the mask body by lifting the front grill element from the mask body at one side of the mask near or at the attachment point. In one embodiment, the front grill element has projections or tabs located near the receiving holes. In another embodiment, the strap attachment points are located near the attachment points. The user may lift the tab 25 (or strap attachment point) to aid in the removal of the front grill element from the mask body. Once the front grill element is removed the used filter element may be exchanged. The front grill element of the mask is replaced, for example, by positioning one of the holes (the first hole) over the corresponding nub (the first nub) on the mask body and pressing the front grill element onto the mask body such that the second hole “snaps” over the second nub. In one embodiment, the front grill element is completely removable from the mask body. In another embodiment, the front grill element is partly removable from the mask body by being hinged or tethered to the mask body.

As indicated above, the filter element may be replaced after removal of the front grill element of the mask body. The used filter element may be removed by pinching the filter and lifting. The new filter has, in one embodiment, a tab located at the top edge of the filter element. Looking at FIG. 3A, a tab recess 30a can be seen at the top of the front grill element. The tab 30b on the filter element, as seen on FIG. 3A, is inserted into the tab recess. FIG. 3B shows where the tab recess 30a and tab 30b can be located if desired. The filter element is then positioned on the front grill element such that it covers the openings between the support elements with the hole in the filter for the exhaust port placed over the exhaust port. The front grill element is then secured onto the mask body to securely hold the filter element, as described above.

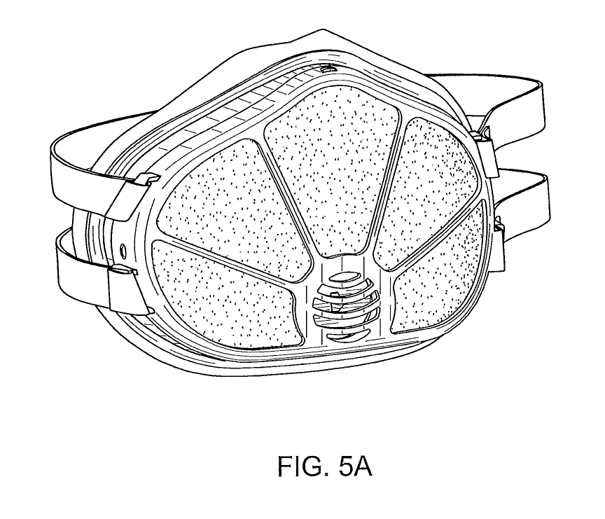

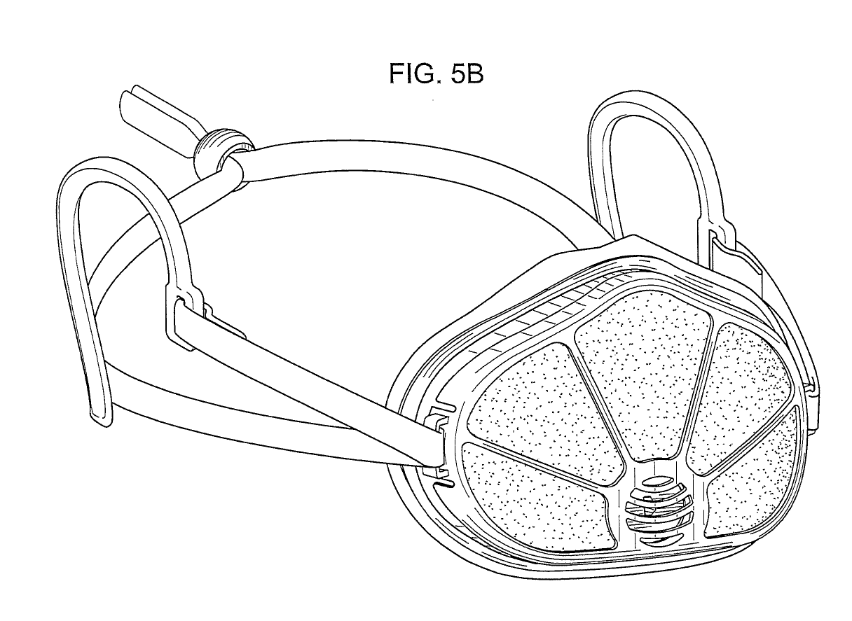

Head gear (i.e., straps and the like) are attached to the front grill element of the face mask of the present invention. This design helps keep the front grill element secured to the mask body when the face mask if being worn by a user. The straps are adjustable for user comfort. The strap or straps may be manufactured from an elastically compliant material in one or more pieces and forms a continuous loop when worn. Embodiments of the head gear of the face mask of the present invention are shown in FIGS. 5A and B.

Further and preferably, the head gear can be as shown in FIG. 5B. The head gear shown in FIG. 5B is superior to head gear known in the art in that it is adjustable and comfortable for use for extended periods of time. The unique attributes of the head gear as shown in FIG. 5B are 1) the ear hooks apply pressure predominantly to the back of the ear and not the top of the ear, which is more comfortable for a user; 2) the attachment strap(s) (referred to herein as the first strap element and second strap element) can be (are preferably) stretchable (i.e., elastic) and 3) the length is easily adjusted with a slide mechanism or other adjustment means thereby allowing the user to adjust the straps for maximum comfort. Other adjustment means may include, for example, snaps, buttons, hook and loop fastener, and the like. The shape of the ear hooks of the head gear of the present invention is novel and non-obvious (see, for example, FIG. 5B). The shape was designed by the inventors of the present invention to locate the center of force applied to the ear to be slightly lower than the mid-point of the back of the ear. Further, the location of the strap attachment point at the front of the ear hook was designed to locate and maintain the center of force applied to the ear slightly lower than the mid-point of the back of the ear. When worn, the positioning of the head gear, the positioning of the strap attachment point and the adjustable nature of the pressure generated by the strap elements keep the mask seal in contact with the user's face. The first strap element and second strap element can be separate straps or portions of one strap.

Further still the head gear of the present invention in combination with the mask seal of the present invention, and in sharp contrast to headgear of the prior art as known to one of ordinary skill in the art, allows the user to adjust the mask pressure generated on the user's face by the using the adjustment mechanism of the straps of the head gear without breaking the mask seal on the user's face.

Further, the present invention is directed toward kits comprising one or more face masks, replacement filter elements and instructions for use.

The terms “about” and “approximately” include the recited number and ±20%, ±10%, ±5% or ±2%.

Any series or range of numbers is inclusive of all values in the series or range even if any particular value is not explicitly stated.

The invention illustratively described herein may be suitably practiced in the absence of any element(s) or limitation(s), which is/are not specifically disclosed herein. Thus, for example, each instance herein of any of the terms “comprising,” “consisting essentially of,” and “consisting of” may be replaced with either of the other two terms. Likewise, the singular forms “a,” “an,” and “the” include plural references unless the context clearly dictates otherwise. Thus, for example, references to “the face mask” includes one or more mask embodiments, which are described herein and/or which will become apparent to those ordinarily skilled in the art upon reading the disclosure.

Variations, modifications, and other implementations of what is described herein will occur to those of ordinary skill in the art without departing from the spirit and the scope of the invention as claimed. Accordingly, the invention is to be defined not by the preceding illustrative description, but instead by the spirit and scope of the following claims.

1. A face mask for holding a removable flexible filter element, said face mask comprising,
a. a mask body contoured to a user's face, said mask body having an opening located substantially forward of the user's mouth and nose, said opening having multiple support elements for providing support to a flexible filter element;
b. a flexible seal positioned on the mask body so as to make a seal between the mask and a user's face when the mask is worn;
c. a removable and reattachable front grill element comprising support elements, said support elements substantially in alignment with the support elements of the mask body when said front grill element is attached to said mask body, said support elements of the mask body and/or front grill element having one or more raised elements and/or fine grip elements, wherein said support elements of the mask body substantially face the support elements of the front grill element when said front grill element is attached to said mask body;
d. a flexible filter element sandwichable between the front grill element and the mask body when said front grill element is attached to the mask body, wherein the raised elements and/or fine grip elements on the support elements of the mask body and/or the support elements of the front grill element substantially keep the flexible filter element from moving parallel to the plain of the flexible filter element.

2. The face mask of claim 1, wherein said flexible filter element is comprised substantially of one material.

3. The face mask of claim 1, wherein said flexible seal is positioned on the mask body so as to make a seal between the mask and a user's face when the mask is worn is substantially V-shaped.

4. The face mask of claim 3, wherein said flexible material has extensions at the position of the mask body that is positioned adjacent to the user's nose when being worn.

5. The face mask of claim 1, wherein the mask body further comprises a one-way valve to allow release of exhaled air.

6. The face mask of claim 6, wherein said one-way valve is positioned in front of the user's mouth when the mask is worn.

7. The face mask of claim 1, wherein said face mask additionally comprises a means for securing the mask to the user's head.

8. The face mask of claim 7, wherein said means for securing the mask to the user's head is attached to the front grill element.

9. The face mask of claim 1, wherein said face mask body and said front grill element being fabricated from a moldable polymer.

10. The face mask of claim 2, wherein said flexible filter element is made from a non-woven fiber material.

11. The face mask of claim 10, wherein said non-woven fiber material is selected from the group consisting of polypropylene, rayon and polyethylene terephthalate (PET).

12. The face mask of claim 1, wherein said flexible filter element is a particulate filter and is electrostatically charged

13. The face mask of claim 1, wherein said filter element further comprises activated charcoal.

14. The face mask of claim 1, wherein flexible seal has two tabs or extensions positioned near the top of the mask such that when worn by a user, the two tabs rest on opposite sides of the user's nose.

15. The face mask of claim 1, wherein said support elements sandwich no more than about 10% of the surface area of the flexible filter element.

16. The face mask of claim 7, wherein said means for securing the mask to the user's head comprises a first and a second ear hook, a first strap element attached to the first ear hook and a second strap element attached to the second ear hook, said first strap element extending through a first head gear connector on the face mask and said second strap element extending though a second head gear connector on the face mask and said first and second strap elements joining with an adjustment mechanism.

17. The face mask of claim 1, wherein when both the mask body and front grill element comprise said fine grip elements, the fine grip elements of the mask body align with the associated fine grip elements of the front grill element.

18. The face mask of claim 1, wherein when both the mask body and front grill element comprise said fine grip elements, the fine grip elements of the mask body do not align with the fine grip elements of the front grill element.

19. A kit having a face mask for holding a removable flexible filter element, the kit comprising;
a. said face mask comprising,
i. a mask body contoured to a user's face, said mask body having an opening located substantially forward of the user's mouth and nose, said opening having multiple support elements for providing support to a flexible filter element;
ii. a flexible seal positioned on the mask body so as to make a seal between the mask and a user's face when the mask is worn;
iii. a removable and reattachable front grill element comprising support elements, said support elements substantially in alignment with the support elements of the mask body when said front grill element is attached to said mask body, said support elements of the mask body and/or front grill element having one or more raised elements and/or fine grip elements, wherein said support elements of the mask body substantially face the support elements of the front grill element when said front grill element is attached to said mask body;
iv. a flexible filter element sandwichable between the front grill element and the mask body when said front grill element is attached to the mask body, wherein the raised elements and/or fine grip elements on the support elements of the mask body and/or the support elements of the front grill element substantially keep the flexible filter element from moving parallel to the plain of the flexible filter element; and
b. instructions for use.
